(19) United States
(12) Patent Application Publication
(10) Pub. No.: US 2017/0258143 A1
(43) Pub. Date: Sep. 14, 2017

(54) ELECTRIC CIGARETTE

(71) Applicant: Harro Hoefliger Verpackungsmaschinen GmbH, Allmersbach im Tal (DE)

(72) Inventor: Edgar LEDERER, Allmersbach im Tal (DE)

(73) Assignee: Harro Hoefliger Verpackungsmaschinen GmbH, Allmersbach im Tal (DE)

(21) Appl. No.: 15/504,352

(22) PCT Filed: Sep. 3, 2014
(86) PCT No.: PCT/DE2014/000448

§ 371 Date: Feb. 16, 2017

(51) Int. Cl. A24F 47/00; H05B 1/02; F22B 1/28

(52) U.S. Cl. CPC A24F 47/008; F22B 1/284; H05B 1/0297

(57) ABSTRACT

An electric cigarette has a heating coil (24) and a wick (20) which is in contact with the heating coil (24) at at least one point. The two ends (26, 28) of the heating coil (24) are arranged in an insulating body (30). A dimensionally stable tube socket (64) is fastened on the insulating body (30). A reservoir (60) which communicates with the wick (20), is arranged in a ring-shaped manner about the tube socket (64). The insulating body (30) and the reservoir (60) are surrounded by a tubular housing (70). According to the invention, each of the two ends (26, 28) of the heating coil (24) is clamped and contacted individually in the insulating body (30), in each case by means of one contact (40, 42). Such an electric cigarette can be produced by a first unit of wick (20), heating coil (24), insulating body (30) and contacts (40, 42) being produced and a second unit of tube socket (64) and reservoir (60) being produced. In the case of the second unit, the reservoir (60) can be filled with the desired liquid from the outside. The two assemblies are fastened together and are then slid into a housing (70). The production of the first and of the second units can be effected in a random order and independently of one another.

### TECHNICAL SCOPE

The invention relates to an electric cigarette, also called an E-cigarette. An electric cigarette is an electrically operated device where a flavored fluid, the so-called liquid, is vaporized. The resultant aerosol is inhaled by the consumer. The most important difference to a conventional cigarette is that in the case of an electric cigarette no combustion process of tobacco or similar takes place. Rather, the vapor of the flavored liquid generates the sensory feel of smoking.

### PRIOR ART

Electric cigarettes are known. They are based, as a rule, on the principle of vaporization and have a power pack or a battery and a vaporizer. The vaporizer and power pack or battery can be present together in one piece or can be obtainable as separate parts. The vaporizers can be obtained as disposable products or can be realized for multiple use. Insofar as the vaporizers are designed for multiple use, they can be filled with liquid by the consumers themselves.

The fluid (liquid) to be vaporized passes from a reservoir to a heating coil as a result of the capillary action of a wick. The liquids can comprise nicotine in various strengths and tastes, however liquids without nicotine can also be obtained.

The production of the electric cigarettes is effected in a purely manual manner. Consequently, the electric cigarettes are produced, as a rule, in Asia. Machine manufacturing of electric cigarettes that are disclosed in the prior art is not known.

### REPRESENTATION OF THE INVENTION

Proceeding from said previously disclosed prior art, the object underlying the invention is to provide an improved electric cigarette which can be manufactured by machine. Furthermore, a method is to be provided in order to be able to manufacture an electric cigarette by means of an assembly device.

The electric cigarette according to the invention is provided by the features of main claim 1. The method according to the invention is provided by the features of subordinate claim 12. Sensible further developments of the invention are the object of further claims which are connected to said claims.

The electric cigarette according to the invention has a heating coil and a wick which is in contact with the heating coil at at least one point. The two ends of the heating coil are arranged in an insulating body. A tube socket, about which a reservoir for the liquid to be vaporized is arranged, is fastened on the insulating body. The wick also communicates with said reservoir. A tubular housing extends around the insulating body and the reservoir. According to the invention, the two ends of the heating coil are clamped and contacted in the insulating body individually in each case by means of one contact. The contacts, in this case, can be realized in particular as insulation displacement contacts or as clamping contacts.

Said contacts, which can be realized in particular as stamped contacts, enable machine manufacturing of the electric cigarette as the ends of the heating coil no longer have to be fastened manually in each case to an electric cable which then serves for connection to an integrated or separate energy source. Rather, a connection technology is now provided which allows for manufacturing on a corresponding assembly device. The mechanical connection between the vaporizer and a separate energy source can essentially be developed in a free manner, threaded solutions in particular having been shown as particularly suitable in the past.

The insulating body can be fastened directly to a separate or integrated energy source. In particular, in the case of integrated energy sources which can preferably be used with single-use products (so-called disposables), such a direct fastening can be advantageous as no further components are necessary.

As an alternative to this, a connection element which is arranged on an end of the housing of the electric cigarette can be present. The connection element can be in electrical contact with the contacts of the insulating body. As a result, the connection element can be fastened to the energy source. The use of a connection element makes it possible not to have to choose which type of mechanical connection is desired between the vaporizer and the energy source until relatively late in the progress of the assembly. Identical insulating bodies could be used in each case independently of said mechanical connection.

In order to obtain manageable intermediate products in the case of such machine manufacturing in as simple and reliable a manner as possible, the tube socket can be fastened on the insulating body preferably by means of at least one latching element. Such a latching element can be formed, for example, by a circumferential ring-shaped thickening on the inside wall of the tube socket which can engage in a corresponding tapering on the insulating body.

In a particularly advantageous embodiment, the tube socket can be part of a small collar tube and consequently comprise a ring-shaped collar at its one end. Said collar can preferably abut against the inside surface of the housing. The collar of the small collar tube can preferably be arranged on the free end of the tube socket which is not fastened on the insulating body. The tube socket of the small collar tube is consequently defined at its one end by the integrated collar and at its other end by the insulating body. As a result, the reservoir for the liquid is delimited toward the consumer by the collar such that a separation area is created between the reservoir and the consumer.

Furthermore, the collar of the small collar tube can serve for the purpose of being able to manage the unit of small collar tube and reservoir which arises when the electric cigarette is manufactured by machine and in particular for being able to grip the collar in a reliable manner. Whereas the electric cigarettes disclosed in the prior art have to be filled, as a rule, after assembly, it is now possible, as a result of said unit, to apply the liquid extensively and homogeneously from the outside to the reservoir as early as in the case of said unit. Such a dosing can be carried out in a reproducible manner with great accuracy. As a result of dosing from the outside, the speed of the dosing operation can furthermore clearly be increased as the liquid can be distributed homogeneously to the reservoir and does not have to be sucked up from an end face of the reservoir through capillary forces. At the same time, the unit can be weighed, for example, after the dosing in order to enable a check on the amount of liquid applied. These types of quality inspections have only been possible up to now in a very limited manner and at great expense.

In a particularly advantageous embodiment, there can be present a mouthpiece which is arranged on the free end of the tube socket or small collar tube and is present at least in part inside the tubular housing of the electric cigarette. The mouthpiece can be pressed from the front into the tubular housing during the assembly, part of the mouthpiece being able to abut from the front against the tubular housing such that the mouthpiece is not able to be slid too far into the tubular housing and a distance between the integrated collar of the small collar tube and the mouthpiece is ensured. The mouthpiece forms the central separation area between the liquid and the consumer and is to prevent very small liquid droplets passing directly into the mouth cavity of the consumer.

The mouthpiece can preferably comprise a circumferential annular channel into which the vapor can enter first of all. Said annular channel can comprise several openings which are distributed over the circumference and are directed toward the consumer and consequently away from the tube socket or the small collar tube. The aerosol can pass out of said openings into the mouth cavity of the consumer. A direct aerosol jet can largely be prevented in this manner, which means a more pleasant feeling in the mouth cavity of the consumer as the aerosol can be distributed regularly in the radial annular channel. The feeling of smoking a conventional cigarette can be recreated in the best possible manner in this way.

In a particularly advantageous embodiment, the mouthpiece can furthermore comprise a baffle region in the center of the annular channel. Said baffle region is an extension of the tube socket of the small collar tube. The baffle region can comprise a concave indentation. Liquid droplets or other particles possibly emerging can collect in said indentation such that they cannot pass directly into the mouth cavity of the consumer. Said type of realization of the mouthpiece is consequently of independent inventive significance and can also be used with the electric cigarettes already disclosed in the prior art.

The insulating body can preferably comprise a radially circumferential edge web, in which at least two indentations which are located opposite one another are present. The wick can be placed in said two indentations such that said wick can be aligned and fixed as early as during the assembly.

In order to facilitate the insertion of the contacts into the insulating body, the insulating body can comprise at least two oppositely situated breakthroughs in which the two ends of the heating coil can be clamped and contacted by means of the contacts. So that the insertion of the contacts is not obstructed by the wick, the two breakthroughs for the contacts can preferably be located next to an imaginary line which runs through the two indentations in the edge web of the insulating body.

In the case of the method according to the invention for manufacturing an electric cigarette by means of at least one assembly device, a first unit from the wick, the heating coil, the insulating body and the contacts is initially produced. Furthermore, a second unit from the tube socket and the reservoir for the liquid is produced. Said two units can be produced by means of the same assembly device and with different assembly devices. The order in which the two units are produced is irrelevant. In the case of the second unit, the reservoir is filled from the outside with the desired liquid. The two units are then fastened together and slid into a housing.

The filling of the liquid can preferably be effected prior to fastening the two units together. However, it would also be possible to fasten the two units together first of all and only then provide the filling of the reservoir with the liquid. The filling of the reservoir with the liquid, however, should preferably take place before the two units are slid into the housing such that the liquid is able to be distributed in the reservoir in a better, homogeneous manner. The fastening of the two units together can be effected on one of the assembly devices on which the production of at least one of the two units is also effected. However, it would also be possible to provide a further assembly device for said assembly step.

The method according to the invention enables the manufacture of an electric cigarette by means of one or several assembly devices as a design of an electric cigarette produced from different units which can be managed individually in a reliable manner is provided for the first time. A fully-automated production line, which can be operated in an economic manner and enables regular and/or inline quality inspections, can be set up in this way.

A mouthpiece can then be pressed into the housing and/or a connection element fitted onto the insulating body. Not until said method steps does a decision have to be made as to how the connection to the energy source is to be effected, as differently realized connection elements can be used in a corresponding manner. A decision on the individual mouthpieces of different manufacturers does not have to be made either until toward the end of the method. The intermediate product present prior to said method steps can already be managed reliably, in particular reliable transport and reliable storage of the same is possible.

The filling of the reservoir can be effected in particular by means of a gripper device. In this case, the reservoir is completely surrounded by a multi-part gripper. Several openings, which are distributed over the circumference and through which a defined amount of liquid can flow into the reservoir, can be present in said gripper. This can be effected, for example, as a result of an increase in pressure inside the gripper. The gripper can preferably compress the reservoir somewhat during the filling operation such that after the filling and the removal of the gripper, it can expand a little in a similar manner to a sponge such that no liquid drips out of the reservoir. This type of filling enables precise dosing and homogeneous distribution of the liquid inside the reservoir. Furthermore, such a filling operation is able to be effected very quickly.

As an alternative to this, the filling of the reservoir could also be effected using a mandrel which can be slid into the reservoir. In said case, the filling of the reservoir should be effected prior to the placing of the reservoir onto the tube socket, that is to say prior to the mounting of the second unit.

After filling the reservoir, the dosing amount can be checked. This serves in particular for quality control. The check can be effected in particular by means of weighing, wherein, depending on the order of the method steps, purely the second unit with the filled reservoir can be weighed—insofar as the two units are only fastened together afterwards—or both units can also be weighed together—insofar as the fastening of the two units together is effected prior to the filling of the reservoir. In order to have as few rejects as possible in the case of an inadvertently incorrect dosing of the liquid, the filling of the reservoir can preferably be effected prior to the fastening of the two units together.

Further advantages and features of the invention are to be found in the features additionally provided in the claims as well as in the following exemplary embodiments.

### BRIEF DESCRIPTION OF THE DRAWING

The invention is described and explained in more detail by way of the exemplary embodiments shown in the drawing, in which:

FIG. 1 shows a schematic view of an electric cigarette according to the invention,

FIG. 2 shows a longitudinal section through the vaporizer of the electric cigarette along the line A-A according to FIG. 1,

FIG. 3 shows a longitudinal section through the vaporizer of the electric cigarette along the line B-B per FIG. 1,

FIG. 4 shows a longitudinal section according to FIG. 2 through a first unit produced from wick, heating coil and an alternative insulating body,

FIG. 5 shows a longitudinal section according to FIG. 3 through the first unit produced from wick, heating coil and an alternative insulating body,

FIG. 6 shows a top view on the first unit per FIGS. 4 and 5,

FIG. 7 shows a longitudinal section through the second unit produced from small collar tube and reservoir,

FIG. 8 shows a longitudinal section according to FIG. 2 through the units according to FIG. 4 and FIG. 7 fastened together,

FIG. 9 shows a longitudinal section according to FIG. 3 through the units according to FIG. 5 and FIG. 7 fastened together and

FIG. 10 shows a longitudinal section through the units according to FIG. 8 fastened together and slid into a housing, a connection element being present in the housing.

### WAYS TO CARRY OUT THE INVENTION

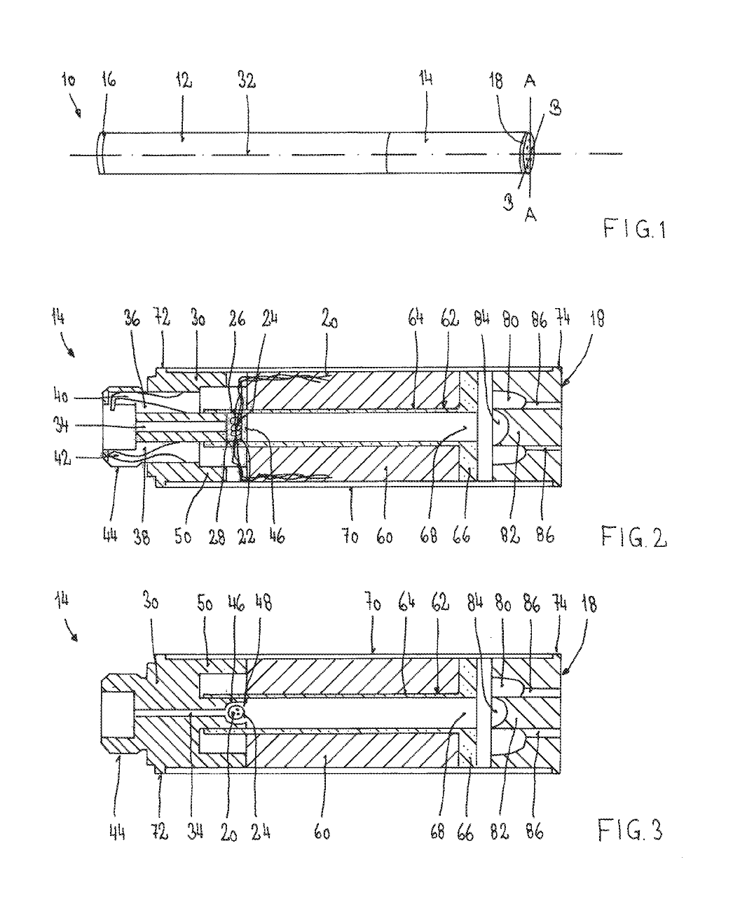

FIG. 1 shows the general design of an electric cigarette 10. The electric cigarette 10 has a power pack 12 as an energy source and a vaporizer 14. Power pack 12 and vaporizer 14 can be fastened together mechanically—in particular by means of a screw thread. A light source 16, which lights up when a drag is taken from the electric cigarette 10, is present on the end face of the power pack 12. The vaporizer 14 is closed at its end-face end by a mouthpiece 18, through which the aerosol passes into the mouth cavity of the consumer.

In the case of the electric cigarette 10, once the liquid has been used up, the vaporizer 14 simply has to be exchanged for a new vaporizer 14. The power pack 12 can be recharged by means of a suitable charger. In contrast to said embodiment, electric cigarettes where the energy source is fixedly connected to the vaporizer are known. Insofar as the vaporizer cannot be filled again manually with liquid, the entire electric cigarette has to be disposed of in this case and exchanged for a new one. The design of the vaporizer 14 described below can also be implemented in the case of such a one-part cigarette.

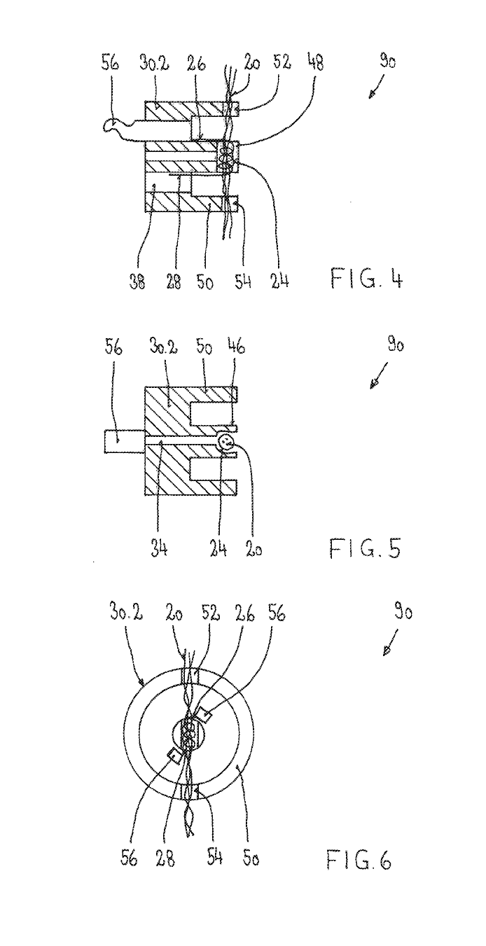

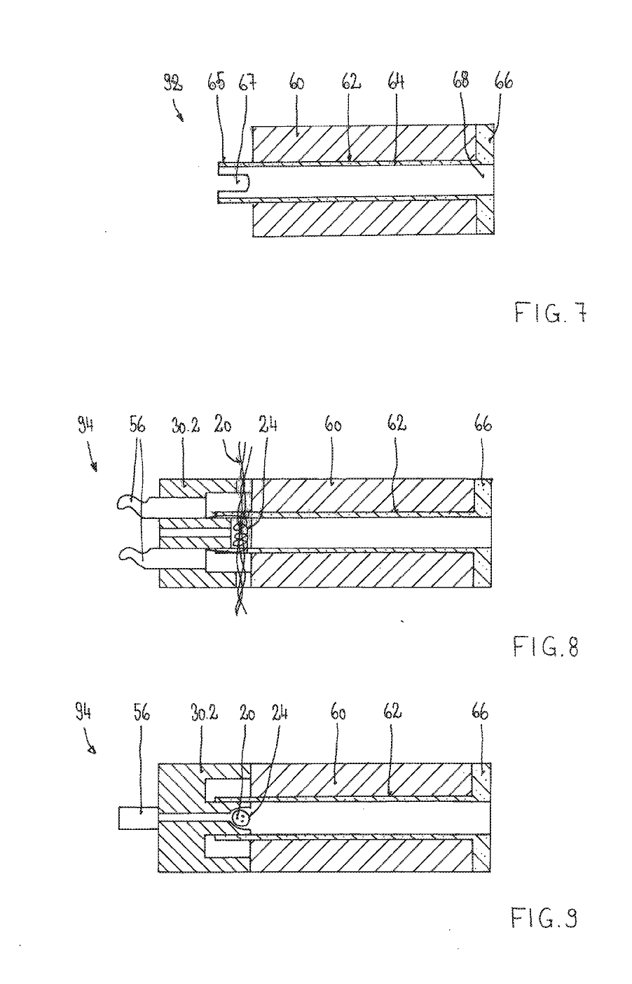

The vaporizer 14 of the electric cigarette 10 is shown in FIGS. 2 and 3 as a longitudinal section along the lines A-A or B-B according to FIG. 1. The vaporizer 14 has a wick 20 which extends through the coils 22 of a heating coil 24. The two ends 26, 28 of the heating coil 24 are fastened and contacted in an insulating body 30.

The insulating body 30 consists of a non-conducting material, in particular of plastics material, which is heat-resistant up to temperatures of approximately 300° C. The insulating body 30 has a continuous air channel 34 which extends in the longitudinal direction 32 of the electric cigarette 10 and through which the surrounding air can be directed through the electric cigarette 10. Two breakthroughs 36, 38, which are spaced apart from one another and also extend in the longitudinal direction 32, are present in the insulating body 30. The two ends 26, 28 of the heating coil 24 are clamped in said two breakthroughs 36, 38. This is effected in each case by means of one contact 40, 42. The contacts 40, 42 are realized as metal punched contacts and serve both for fixing the two ends 26, 28 of the heating coil 24 in the insulating body 30 and as energy transmitters for the contacts of the connected energy source (power pack 12) through the heating coil 24. This type of fastening of the heating coil 24 on an insulating body 30 by means of contacts 40, 42 can be produced by means of suitable assembly devices such that manual assembly is no longer necessary.

The contacts 40, 42 emerge at the rear end (shown on the left in the drawing) of the insulating body 30 from said insulating body and can be connected to corresponding contacts of an energy source. In the present example, the insulating body 30 is realized at its rear end with an external thread 44 such that the insulating body 30 could be directly connected to the power pack 12. The power pack 12 would simply have to comprise a corresponding internal thread for this purpose. In dependence on the desired or already present connection possibilities of the power packs 12 disclosed in the prior art, the insulating body 30 could be provided with alternative connection possibilities matching the desired power pack 12 instead of the external thread 44.

The heating coil 24 with the wick 20 is placed in a widening of the air channel 34. For this purpose, the insulating body comprises a central tube socket 46 in which the air channel 34 extends. The tube socket 46 comprises on its free end region a channel-shaped indentation 48 which extends approximately perpendicular to the air channel 34 and forms the widening. The channel-shaped indentation 48, in this case, is aligned such that the two ends 26, 28 of the heating coil 24 are automatically positioned in the breakthroughs 36, 38 as soon as the heating coil 24 is inserted into the insulating body. A further alignment of the heating coil 24 is not necessary. Rather, the fastening and fixing of the heating coil 24 in the channel-shaped indentation 48 can be directly effected by means of the external diameter thereof. Furthermore, both ends 26, 28 of the heating coil 24 can be fixed and contacted by means of the contacts 40, 42.

The insulating body 30 has a radially circumferential edge web 50 on its outer edge region. The edge web 50 serves as a spacer between the contacts 40, 42 and the reservoir 60. Furthermore, the edge web 50 can facilitate the positioning of the contacts 40, 42 in the breakthroughs 36, 38 (see also FIG. 6).

A small collar tube 62 can be fastened on the central tube socket 46. The small collar tube 62 has a tube socket 64 with a disk-shaped collar 66. The free end of the tube socket 64 of the small collar tube 62 can be slid over the central tube socket 46 of the insulating body 30 in order to fasten the small collar tube 62 on the insulating body 30. It can be sufficient, in this case, simply to insert the small collar tube 62 and the insulating body 30 into one another in order to obtain a sufficiently strong fastening together. It would also be possible to provide a latching element on the small collar tube 62 and/or the insulating body 30 in order to secure the fastening additionally. The tube socket of the small collar tube 62 can also effect additional fixing of the heating coil 24 and of the wick 20.

The reservoir 60, which can be filled with the desired liquid, is present around the tube socket 64 of the small collar tube 62. The filling of the reservoir 60 can be effected from the outside, for example by means of an injection or a dipping operation. The filling can preferably be effected by means of a gripping device which encompasses the entire reservoir 60 and provides it with a defined amount of liquid. Once the reservoir 60 has been filled, it can be weighed in order to check the amount of filled liquid. With the external dimensions remaining constant, a longer reservoir can be used in the case of this embodiment such that more storage capacity is created. The electric cigarette 10 can therefore be filled with a greater amount of liquid such that it has a longer service life. As an alternative to this, the external dimensions in the longitudinal direction 32 of the electric cigarette 10 could be reduced without storage capacity having to be waived.

A tubular housing 70 is present around the reservoir 60, the small collar tube 62 and the insulating body 30, said housing abutting in a play-free manner against said components. In the present example, the housing 70 abuts against a shoulder characteristic 72 of the insulating body 30 in order to enable a defined position of the insulating body 30 in the housing 70. A small part of the insulating body 30 would consequently be visible. Insofar as this is not desired, said part of the insulating body 30, together with at least part of the housing 70, could be provided with an adhesive. Such an adhesive could simulate, for example, the visual impression of a conventional cigarette and/or show constituents or manufacturer specifications.

The housing 70 projects a little beyond the collar 66 of the small collar tube 62. A mouthpiece 18 can be pressed forward into said free part. For this purpose, the mouthpiece 18 comprises a shoulder characteristic 74 which abuts against the front edge of the housing 70.

In the present example, the mouthpiece 18 comprises a circumferential annular channel 80. The inner delimitation of the annular channel 80 is effected by a baffle region 82 which is present as an extension of the tube socket 64 of the small collar tube 62. The baffle region 82 comprises a concave indentation 84. Very small liquid droplets and/or other particles which are inadvertently present in the air current and emerge through the central opening 68 of the collar 66 of the small collar tube 62, are collected in said concave indentation 84 such that they are not able to pass into the mouth cavity of the consumer. The baffle region 82 is simply arranged, consequently, at a small distance from the collar 66 of the small collar tube 62. The aerosol is distributed in the annular channel 80 of the mouthpiece 18 and is able to emerge out of the annular channel 80 through several openings 86 distributed on the circumference and pass into the mouth cavity of the consumer.

In the present example, the annular channel 80 is formed completely by the mouthpiece 18. In contrast to said embodiment, the annular channel could also be delimited on its outside surface by the housing of the electric cigarette.

The diameter of the central opening 68 of the collar 66 of the small collar tube 62 can correspond at most to the diameter of the tube socket 64, as is also shown in the drawing. As an alternative to this, the diameter of said central opening 68 could also be chosen to be smaller.

FIGS. 4 to 10 show an alternative embodiment of an electric cigarette during the assembly of such an electric cigarette. The assembly runs in an analogous manner to the electric cigarette 10 according to FIGS. 2 and 3.

A first unit 90, which is shown in FIGS. 4, 5 and 6, is produced first of all for the assembly. To this end, a heating wire is wound around a wick 20 such that a heating coil 24 is formed. The wick 20 could possibly also be threaded through the coils 22 of a heating coil 24. The wick 24 is then placed in two oppositely situated indentations 52, 54 of the edge web 50 of the insulating body 32.2 and the heating coil 24 is placed in the channel-shaped indentation 48 of the insulating body 30.2. The two ends 26, 28 of the heating coil 24 automatically come to rest, as a result, in the breakthroughs 36, 38 of the insulating body 30.2. The wick 20 can preferably be present as an endless wick.

The two ends 26, 28 of the heating coil 24 are clamped in the breakthroughs 36, 38 of the insulating body 30.2 by means of two contacts 56. In FIG. 4 just one contact 56 is already clamped in the breakthrough 36. The second end 28 of the heating coil 24, in contrast, still lies loosely in the breakthrough 38. In the case of the finished unit 90, however, both contacts 56 are present in the breakthroughs 36, 38. The two contacts 56 can be mounted one after another or at the same time.

As in the case of the embodiment shown in FIGS. 4 to 10, a connection element is present in addition to the insulating body 30.2 (see FIG. 10), contacts 56 other than those in the case of the first embodiment according to FIGS. 2 and 3 have to be used. Two identical contacts 56 can be used for this purpose in the case of the second embodiment, whereas in the case of the first embodiment different contacts 40, 42 had to be used.

The insulating body 30.2 differs from the insulating body 30 according to FIGS. 2 and 3 in that it does not offer any mechanical connection possibility for direct connection to an energy source. The insulating body 30.2 would consequently have to be connected to an integrated energy source inside the housing 70 or to a further connection element which comprises mechanical connection possibilities—for example a corresponding thread—in order to be able to connect this to a separate energy source.

A second unit 92, which is shown in FIG. 6, is produced along with the first unit 90. The two units 90, 92 can be produced parallel to one another or independently of one another, the order of their production being independent of one another. The assembly of the two units can be effected on the same assembly device, however, it is also possible to provide two different assembly devices. The two units 90, 92 can be transported and stored in their respective finished state such that no direct manufacturing of the electric cigarette 10 is necessary.

The second unit 92 consists, in the present example, of the dimensionally stable small collar tube 62 and the reservoir 60. The reservoir 60 is slid over the tube socket 64 of the small collar tube 62 until it abuts against the collar 66. In said state, the second unit 92 is able to be gripped in particular about the collar 66. As an alternative to this, the second unit 92 could also be gripped and transported with a mandrel which can be inserted into the central bore. The end 65 of the tube socket 64 of the small collar tube 62, in the present example, comprises two recesses 67 which are situated opposite one another. The wick 20 can extend in said recesses 67 as soon as the end 65 of the tube socket 64 has been fastened on the first unit 90.

It is particularly advantageous that the second unit 92 enables the reservoir 60 to be filled with the desired liquid from the outside. The desired liquid consequently no longer has to be filled from the end face of the reservoir 60, which takes a very long time as a result of the weak capillary forces of the reservoir 60. In contrast, the filling of the reservoir over the entire length of the same can be effected in a rapid and homogeneous manner. Furthermore, the second unit 92 can be weighed after the filling with the liquid in order to ensure that the correct amount of liquid is present in the reservoir 60. Quality control can take place in this way.

The filling of the reservoir 60 should preferably be effected directly prior to the fastening of the two units 90, 92 together. As a result, no unit 90 has to be dispensed with insofar as the quality control of the filled liquid turns out to be unsatisfactory. Furthermore, there can be no loss of liquid in the case of direct further processing.

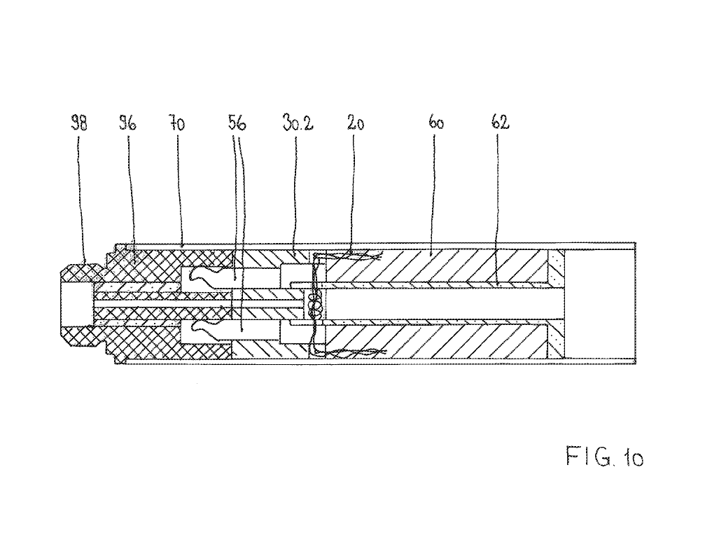

The two units 90, 92 are fastened together by the tube socket 64 of the small collar tube 62 of the second unit 92 being slid over the central tube socket 46 of the insulating body 30 of the first unit 90. The intermediate product 94 shown in FIGS. 8 and 9 can be formed in this way.

Said intermediate product 94 can then be slid into the housing 70. The external diameter of the insulating body 30.2, in this case, is chosen such that it sits sufficiently firmly in the housing 70.

Furthermore, the housing 70 can be provided with a connection element 96, as is shown in FIG. 10. The connection element 96, in the present example, abuts directly against the insulating body 30.2. Connection element 96 and insulating body 30.2 could, however, also be arranged at a certain mutual distance from one another as long as it is ensured that the contacts 56 are in electrical contact with the connection element 96.

The connection element 96, in the present example, is realized with an external thread 98 such that the connection element could be connected to a power pack 12. The power pack 12 would simply have to comprise a corresponding internal thread for this purpose. In dependence on the desired or already present connection possibilities of the power packs 12 disclosed in the prior art, the connection element 96 could be provided with alternative connection possibilities which match the desired power pack 12 instead of the external thread 98. The housing 70 could then still be provided with the desired mouthpiece 18.

A relatively long wick 20 was used in the present example. It would also be possible to use a clearly shorter wick 20 which only covers the end face of the reservoir 60 and does not project beyond said end face. This can be advantageous for further assembly, in particular for inserting the intermediate product 94 into the housing 70.

1. An electric cigarette (10)
having a heating coil (24),
having a wick (20) which is in contact with the heating coil (24) at at least one point,
having an insulating body (30, 30.2) in which the two ends (26, 28) of the heating coil (24) are arranged,
having a dimensionally stable tube socket (64) which is fastened on the insulating body (30, 30.2),
having a reservoir (60) which is arranged in a ring-shaped manner about the tube socket (64) and communicates with the wick (20),
having a tubular housing (70) which surrounds the insulating body (30, 30.2) and the reservoir (60),
wherein
each of the two ends (26, 28) of the heating coil (24) is clamped and contacted individually in the insulating body (30, 30.2) in each case by means of one contact (40, 42, 56).

2. The electric cigarette as claimed in claim 1,
wherein
a connection element (96), which is arranged on one end of the housing (70), is present,
electrical contacting exists between the connection element (96) and the contacts (56) of the insulating body (30.2).

3. The electric cigarette as claimed in claim 1,
wherein
an energy source, which is connected to the tubular housing, is present.

4. The electric cigarette as claimed in claim 1,
wherein
the tube socket is fastened on the insulating body by means of at least one latching element.

5. The electric cigarette as claimed in claim 1,
wherein
the tube socket (64) comprises a collar (66) at its one end and is consequently realized as a small collar tube (62).

6. The electric cigarette as claimed in claim 5,
wherein
the collar (66) of the small collar tube (62) is arranged on the free end of the tube socket (64).

7. The electric cigarette as claimed in claim 1,
wherein
a mouthpiece (18) is present,
the mouthpiece (18) is arranged on the free end of the tube socket (64),
the mouthpiece (18) is arranged at least in part inside the tubular housing (70).

8. The electric cigarette as claimed in claim 7,
wherein
the mouthpiece (18) comprises a circumferential annular channel (80),
annular channel (80) comprises several openings (86) which are distributed over the circumference and are directed away from the tube socket (64).

9. The electric cigarette as claimed in claim 7,
wherein
the mouthpiece (18) comprises a baffle region (82),
the baffle region (82) is arranged as an extension of the tube socket (64) of the small collar tube (62),
the baffle region (82) comprises a concave indentation (84).

10. The electric cigarette as claimed in claim 1,
wherein
the insulating body (30.2) comprises a radially circumferential edge web (50),
at least two indentations (52, 54), which are located opposite one another and in which the wick (20) is placed, are present in the edge web (50).

11. The electric cigarette as claimed in claim 10,
wherein
the insulating body (30.2) comprises at least two breakthroughs (36, 38) which are located opposite one another and in which the two ends (26, 28) of the heating coil (24) are clamped and contacted in each case by means of one contact (56),
the two breakthroughs (36, 38) which are provided with contacts (56) are located outside a line which runs through the two indentations (52, 54) of the edge web (50).

12. A method for manufacturing an electric cigarette (10) by means of at least one assembly device with the following method steps
a) a first unit (90) is produced from wick (20), heating coil (24), insulating body (30, 30.2) and contacts (40, 42, 56),
b) a second unit (92) is produced from tube socket (64) and reservoir (60),
c) in the case of the second unit (92), the reservoir (60) is filled with the desired liquid from the outside,
d) the first unit (90) and the second unit (92) are fastened together,
e) they are then slid into a housing (70),
f) wherein the production of the first and of the second units (90, 92) according to method steps a) and b) can be effected in a random order and independently of one another.

13. The method as claimed in claim 12,
wherein
after method step f), a connection element (96) is slid into the housing (70) such that electrical contacting exists between the connection element (96) and the contacts (56) of the insulating body (30.2).

14. The method as claimed in claim 12,
wherein
the filling of the reservoir (60) with the desired liquid is effected in method step c) by means of a gripping device.

15. The method as claimed in claim 12,
wherein
after the reservoir (60) has been filled in method step c), the dosing amount is checked, in particular by means of weighing.
